(19) United States
(12) Patent Application Publication
(10) Pub. No.: US 2024/0304359 A1
(43) Pub. Date: Sep. 12, 2024

(54) Shielded Extension Cord Device And Method Of Use

(71) Applicants: Matthew Bologna, Rancho Palos Verde, CA (US); John R. Marovich, Rancho Palos Verde, CA (US)

(72) Inventors: Matthew Bologna, Rancho Palos Verde, CA (US); John R. Marovich, Rancho Palos Verde, CA (US)

(21) Appl. No.: 18/117,797

(22) Filed: Mar. 6, 2023

(51) Int. Cl. H01B 7/20; H01B 7/04

(52) U.S. Cl. CPC H01B 7/207; H01B 7/04

(57) ABSTRACT

A shielded extension cord device that is resistant to kinking, tangling, and damage includes an electrical cord, which comprises at least two conducting wires. A plug and a socket are attached to a first end and a second end of the electrical cord, respectively, so that the socket is electrically engaged to the plug. A sheath is positioned around the electrical cord and extends substantially between the plug and the socket. The sheath comprises a plurality of sections, the sections of which are pivotally interconnected and substantially rigid so that the sheath is bendable along its length but substantially incompressible along its diameter.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to extension cords and more particularly pertains to a new extension cord that is resistant to kinking, tangling, and damage. The present invention discloses an extension cord that is shielded by a flexible sheath to reduce a likelihood of the extension cord being damaged.

### (2) Description of Related Art Including Information Disclosed Under 37 CFR 1.97 and 1.98

The prior art relates to extension cords, which may comprise devices that snap around electrical cords, devices comprising a plurality of rigid tubular segments that are hingedly engaged and positioned around an electrical cord, devices comprising a plurality of interlocked thimbles positioned around an electrical cord, and extension cords having spiral members positioned therearound to limit tangling. Related prior art comprises soft sheathes for electrical cords to limit damage to surfaces that come into contact with the electrical cords. What is lacking in the prior art is an extension cord covered with a sheath comprising a plurality of sections, the sections of which are pivotally interconnected and substantially rigid so that the sheath is bendable along its length but substantially incompressible along its diameter

### BRIEF SUMMARY OF THE INVENTION

An embodiment of the disclosure meets the needs presented above by generally comprising an electrical cord, which comprises at least two conducting wires. A plug and a socket are attached to a first end and a second end of the electrical cord, respectively, so that the socket is electrically engaged to the plug. A sheath is positioned around the electrical cord and extends substantially between the plug and the socket. The sheath comprises a plurality of sections, the sections of which are pivotally interconnected and substantially rigid so that the sheath is bendable along its length but substantially incompressible along its diameter.

Another embodiment of the disclosure include a method of connecting an electrical device to an outlet. The method comprises a provision step, which entails providing an electrical device and a shielded extension cord device, according to the disclosure above. A first connection step of the method is plugging the plug of the shielded extension cord device into an outlet. A second connection step of the method is plugging a plug of the electrical device into the socket of the shielded extension cord device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a shielded extension cord device according to an embodiment of the disclosure.

FIG. 2 is a side view of an embodiment of the disclosure.

FIG. 3 is a cross-sectional view of an embodiment of the disclosure.

FIG. 4 is an in-use view of an embodiment of the disclosure.

FIG. 5 is a flow diagram for a method utilizing an embodiment of the disclosure.

### DETAILED DESCRIPTION OF THE INVENTION

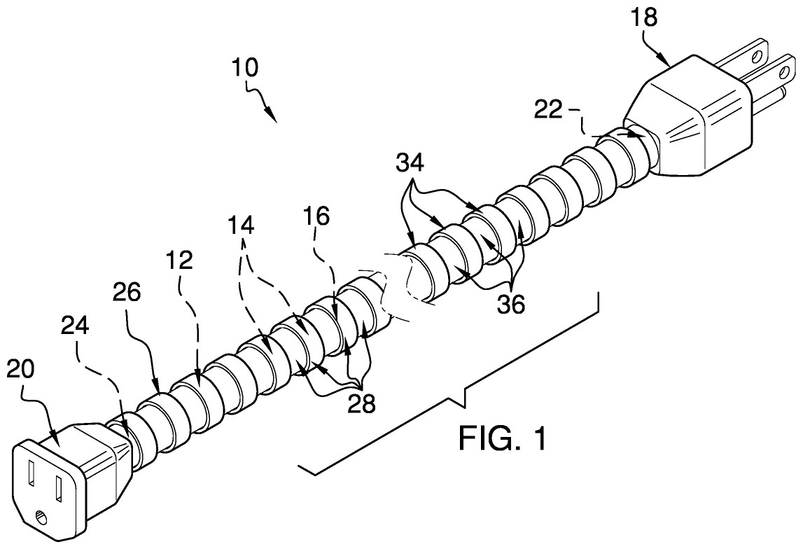

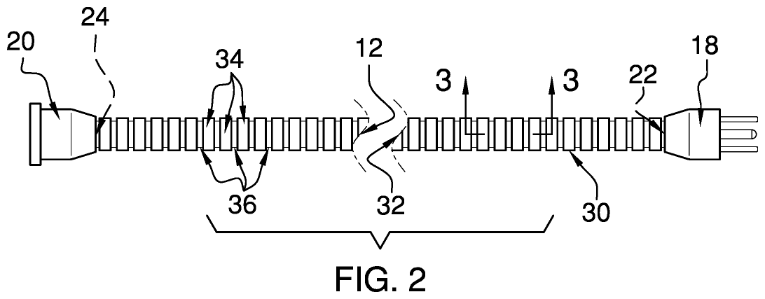

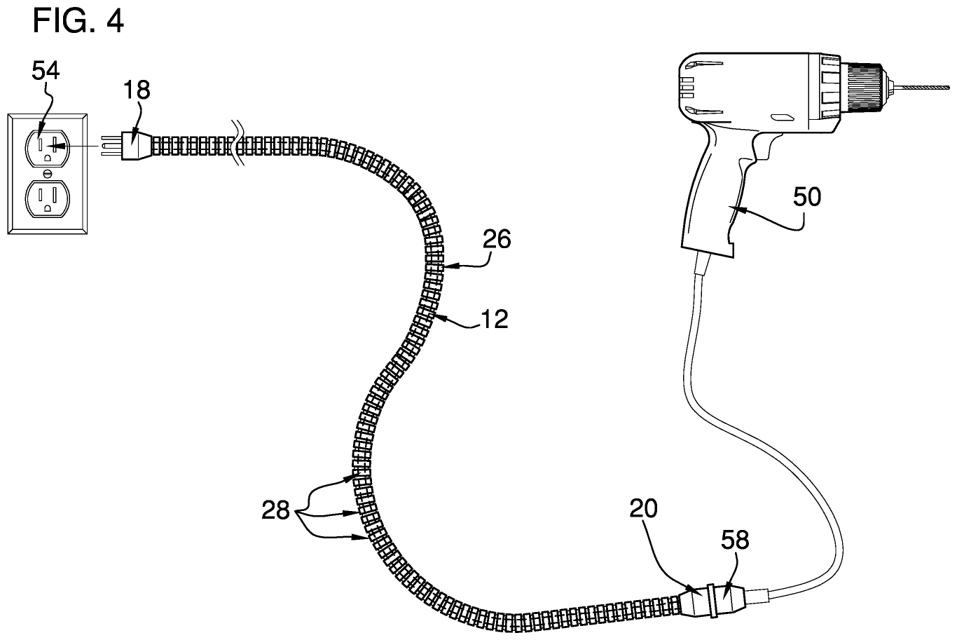

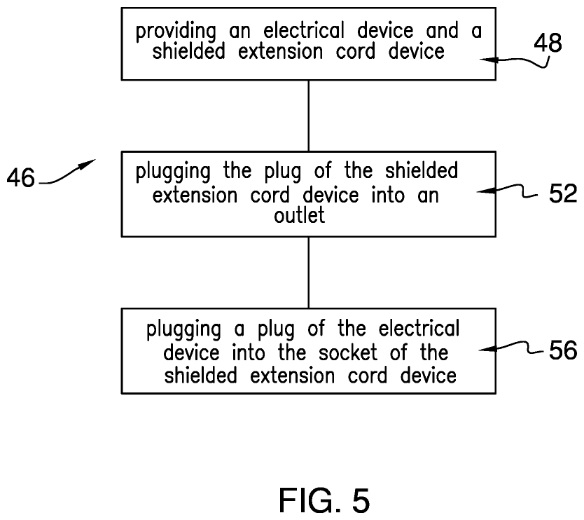

With reference now to the drawings, and in particular to FIGS. 1 through 5 thereof, a new extension cord embodying the principles and concepts of an embodiment of the disclosure and generally designated by the reference numeral 10 will be described.

As best illustrated in FIGS. 1 through 5, the shielded extension cord device 10 generally comprises an electrical cord 12, which comprises at least two conducting wires 14. Construction and materials for such electrical cords 12 are well known to those skilled in the art and typically comprise two or more conducting wires 14 and one or more ground wires 16, which are electrically insulated from one another and wrapped in a water resistant material. The electrical cord 12 may comprise conducting wires 14 and ground wires 16 in appropriate quantities and gauges so that they are configured for single phase and triple phase at voltages from 110V to 240V.

A plug 18 and a socket 20 are attached to a first end 22 and a second end 24 of the electrical cord 12, respectively, so that the socket 20 is electrically engaged to the plug 18. The present invention also anticipates the socket 20 comprises a plurality of sockets 20.

A sheath 26 is positioned around the electrical cord 12 and extends substantially between the plug 18 and the socket 20. The sheath 26 comprises metal, such as stainless steel, brass, or the like, or other substantially rigid material, such as elastomer, or the like. The sheath 26 comprises a plurality of sections 28, the sections 28 of which are pivotally interconnected and substantially rigid so that the sheath 26 is bendable along its length 30 but substantially incompressible along its diameter 32. The shielded extension cord device 10 thus is configured to resist kinking and twisting and to be resistant to damage, such as from inadvertent contact with a cutting implement.

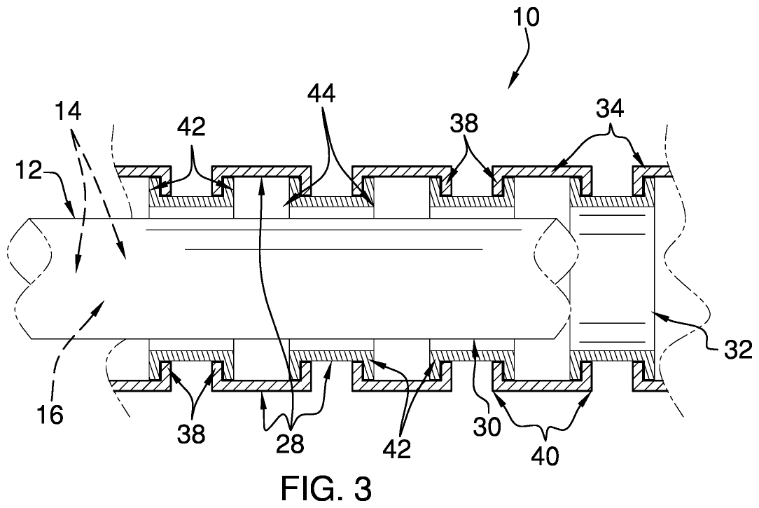

The plurality of sections 28 comprises a plurality of outer rings 34 and a plurality of inner rings 36, each inner ring 36 of which is bracketed by a pair of outer rings 34. Each outer rim 38 of a plurality of outer rims 38 is attached to an opposed edge 40 of a respective outer ring 34 so that an outer rim 38 is attached to each opposed edge 40 of each outer ring 34. The outer rim 38 extends radially toward the electrical cord 12. Each inner rim 42 of a plurality of inner rims 42 is attached to an opposing edge 44 of a respective inner ring 36 so that an inner rim 42 is attached to each opposing edge 44 of each inner ring 36. The inner rims 42 of each inner ring 36 extend radially away from the electrical cord 12 and into a pair of outer rings 34, as shown in FIG. 3, so that the inner ring 36 is pivotally engaged to the pair of outer rings 34.

The shielded extension cord device 10 enables a method of connecting an electrical device to an outlet 46. The method 46 comprises a provision step 48, which entails providing an electrical device 50 and a shielded extension cord device 10, according to the specification above. A first connection step 52 of the method 46 is plugging the plug 18 of the shielded extension cord device 10 into an outlet 54. A second connection 56 step of the method 46 is plugging a plug 58 of the electrical device 50 into the socket 20 of the shielded extension cord device 10. The ordering of the first connection step 52 and the second connection step 56 can be reversed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A shielded extension cord device comprising:
an electrical cord comprising at least two conducting wires;
a plug attached to a first end of the electrical cord;
a socket attached to a second end of the electrical cord, such that the socket is electrically engaged to the plug; and
a sheath positioned around the electrical cord and extending substantially between the plug and the socket, the sheath comprising a plurality of sections, the sections being pivotally interconnected and substantially rigid, such that the sheath is bendable along its length but substantially incompressible along its diameter.

2. The shielded extension cord device of claim 1, wherein the sheath comprises metal.

3. The shielded extension cord device of claim 2, wherein the sheath comprises stainless steel.

4. The shielded extension cord device of claim 1, wherein the plurality of sections comprises:
a plurality of outer rings;
a plurality of outer rims, each outer rim being attached to an opposed edge of a respective outer ring such that an outer rim is attached to each opposed edge of each outer ring, the outer rim extending radially toward the electrical cord;
a plurality of inner rings, each inner ring being bracketed by a pair of outer rings; and
a plurality of inner rims, each inner rim being attached to an opposing edge of a respective inner ring such that an inner rim is attached to each opposing edge of each inner ring, the inner rims of each inner ring extending radially away from the electrical cord and into a pair of outer rings, such that the inner ring is pivotally engaged to the pair of outer rings.

5. A shielded extension cord device comprising:
an electrical cord comprising at least two conducting wires;
a plug attached to a first end of the electrical cord;
a socket attached to a second end of the electrical cord, such that the socket is electrically engaged to the plug; and
a sheath positioned around the electrical cord and extending substantially between the plug and the socket, the sheath comprising a plurality of sections, the sections being pivotally interconnected and substantially rigid, such that the sheath is bendable along its length but substantially incompressible along its diameter, the sheath comprising metal, the sheath comprising stainless steel, the plurality of sections comprising:
a plurality of outer rings,
a plurality of outer rims, each outer rim being attached to an opposed edge of a respective outer ring such that an outer rim is attached to each opposed edge of each outer ring, the outer rim extending radially toward the electrical cord,
a plurality of inner rings, each inner ring being bracketed by a pair of outer rings, and
a plurality of inner rims, each inner rim being attached to an opposing edge of a respective inner ring such that an inner rim is attached to each opposing edge of each inner ring, the inner rims of each inner ring extending radially away from the electrical cord and into a pair of outer rings, such that the inner ring is pivotally engaged to the pair of outer rings.

6. A method of connecting an electrical device to an outlet comprising the steps of:
providing an electrical device and a shielded extension cord device, the shielded extension cord device comprising:
an electrical cord comprising at least two conducting wires,
a plug attached to a first end of the electrical cord,
a socket attached to a second end of the electrical cord, such that the socket is electrically engaged to the plug, and
a sheath positioned around the electrical cord and extending substantially between the plug and the socket, the sheath comprising a plurality of sections, the sections being pivotally interconnected and substantially rigid, such that the sheath is bendable along its length but substantially incompressible along its diameter;
plugging the plug of the shielded extension cord device into an outlet; and
plugging a plug of the electrical device into the socket of the shielded extension cord device.

7. The method of claim 6, wherein the sheath comprises metal.

8. The method of claim 7, wherein the sheath comprises stainless steel.

9. The method of claim 6, wherein the plurality of sections comprises:
a plurality of outer rings;
a plurality of outer rims, each outer rim being attached to an opposed edge of a respective outer ring such that an outer rim is attached to each opposed edge of each outer ring, the outer rim extending radially toward the electrical cord;
a plurality of inner rings, each inner ring being bracketed by a pair of outer rings; and
a plurality of inner rims, each inner rim being attached to an opposing edge of a respective inner ring such that an inner rim is attached to each opposing edge of each inner ring, the inner rims of each inner ring extending radially away from the electrical cord and into a pair of outer rings, such that the inner ring is pivotally engaged to the pair of outer rings.
